(19) United States
(12) Patent Application Publication
(10) Pub. No.: US 2010/0287386 A1
(43) Pub. Date: Nov. 11, 2010

(54) SECURE INTEGRATED CIRCUIT COMPRISING MEANS FOR DISCLOSING COUNTERPART MASK VALUES

(75) Inventors: Benoît FEIX, Aubagne (FR); Sébastien NEROT, Jouques (FR); Gary CHEW, Aix en Provence (FR); Bernard VIAN, Gemenos (FR)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: INSIDE CONTACTLESS, Aix enProvence Cedex 3 (FR)

(21) Appl. No.: 12/775,678

(22) Filed: May 7, 2010

(30) Foreign Application Priority Data
May 7, 2009 (FR) 09 02205

(51) Int. Cl. G06F 12/14

(52) U.S. Cl. 713/193; 713/189

(57) ABSTRACT

An integrated circuit includes a communication interface circuit, a cryptographic algorithm, a countermeasure configured to protect the cryptographic algorithm against side-channel attacks, and a mask generator configured to provide the countermeasure with mask values. The integrated circuit is configured to execute a specific command requiring the disclosure of mask values used by the countermeasures to protect the cryptographic algorithm during a cryptographic session, and, in response to such a command, to send the mask values through the communication interface circuit.

### BACKGROUND OF THE INVENTION

Embodiments of the present invention relate to an integrated circuit having a communication interface circuit, a cryptographic algorithm, a countermeasure configured to protect the cryptographic algorithm against side-channel attacks, and a mask generator configured to provide the countermeasure with mask values.

Embodiments of the present invention are particularly, but not exclusively, directed to integrated circuits for chip cards.

FIG. 1 shows a conventional integrated circuit IC1 including a microprocessor MP, a secure memory SM, a cryptographic algorithm CA, a countermeasure CM and a mask generator MG. The integrated circuit IC1 also includes a communication interface circuit INT1 to exchange data with an external device ED such as a chip card reader, which also includes a communication interface circuit INT2. The secure memory SM contains a secret key K for the cryptographic algorithm CA. The cryptographic algorithm CA performs a cryptographic function FK using the secret key K to transform initial data DT into encrypted data FK(DT).

The cryptographic algorithm CA is used by the integrated circuit to encrypt secret data to be sent to the external device ED. In the field of chip cards performing secure applications (transactions, access control, or the like), the cryptographic algorithm CA is often used to perform the authentication of the integrated circuit IC1 by the external device ED, and sometimes is used to perform the authentication of the external device ED by the integrated circuit IC1.

For example, the external device ED sends a “challenge” DT, generally random data, then the integrated circuit IC1 encrypts the challenge with the cryptographic algorithm CA and provides the external device ED with the result FK(DT). The external device ED then compares this response with the expected result, which it has calculated with its own cryptographic algorithm. If the two are the same, then the integrated circuit IC1 is considered as authentic and is authorized to perform the transaction.

The key K or other secret information held by the integrated circuit is therefore subjected to attacks from fraudsters. So-called “side channel attacks” use information that can be observed or detected by the attacker in order to determine parameters of the cryptographic algorithm, such as the key. Side channel attacks can be implemented against all types of cryptographic algorithms and provide information about the state of the cryptographic algorithm. Side channel attacks can be either passive, such as monitoring of the timing or power consumption (Simple Power Analysis SPA or Differential Power Analysis DPA) of the computations, or active, such as the introduction of faults during sensitive operations (Differential Fault Analysis DFA).

The countermeasure CM is provided to hinder or at least to slow down such side-channel attacks by using mask values Mi (M1, M2, . . . Mm). These mask values Mi are provided by the mask generator MG1, which generally includes a random or pseudo-random number generator. Such mask values Mi are unknown by the attacker and allow the operation of the cryptographic algorithm CA to be obscured, such as by an exclusive or (XOR) operation applied to the data to be encrypted, to the key, or both, or are used to scramble the order of operations in which the cryptographic algorithm calculates the result FK(DT). Intermediary data, such as a single iteration of a multi-iteration cryptographic algorithm, can also be modified by the mask values Mi. Observable external physical parameters, such as the electric consumption of the integrated circuit during a cryptographic session, are consequently altered.

Side channel attacks are thus rendered ineffective or much more difficult to carry out since the observance of the execution of the cryptographic algorithm CA does not reveal the secrets of the integrated circuit. However, since one or more mask values Mi are randomly or pseudo-randomly generated and used each time the cryptographic algorithm CA is executed, the cryptographic algorithm CA cannot be executed more than once with the same parameters. This causes difficulties during the design or debugging process because the mask values Mi are unpredictable from the outside.

Therefore, it is desired to provide a cryptographic algorithm having a countermeasure that may be tested and debugged without impairing the security of the cryptographic algorithm.

### BRIEF SUMMARY OF THE INVENTION

More particularly, embodiments of the invention relate to an integrated circuit including a communication interface circuit, a cryptographic algorithm, a countermeasure configured to protect the cryptographic algorithm against side-channel attacks, and a mask generator configured to provide the countermeasure with mask values. The integrated circuit is configured to execute a specific command requiring the disclosure of mask values used by the countermeasure to protect the cryptographic algorithm during a cryptographic session, and, in response to such a command, to send the mask values through the communication interface circuit.

According to one embodiment, the integrated circuit includes a random or pseudo-random mask generator and is configured to store in a secure memory, during a cryptographic session, mask values used by the countermeasure to protect the cryptographic algorithm, and in response to the specific command, read the mask values in the secure memory.

According to one embodiment, the integrated circuit includes a mask generator configured to generate mask values from a deterministic sequence number, and is configured to, in response to the specific command, regenerate, via the mask generator, mask values used during a cryptographic session.

According to one embodiment, the integrated circuit is configured to count the number of times the specific command was executed, and to not execute the command if it has been executed N times.

According to one embodiment, the integrated circuit is configured to perform a security action if the specific command is received after having been executed N times.

According to one embodiment, the integrated circuit is configured to permanently lock if the specific command is received after having been executed N times.

According to one embodiment, the number N of times the specific command can be executed is defined by a parameter securely stored in the integrated circuit.

According to one embodiment, the integrated circuit is configured so that the number N of times the specific command can be executed is lower than the estimated number of times that would be necessary for an attacker knowing the mask values to successfully carry out a side-channel attack of the cryptographic algorithm.

According to one embodiment, the integrated circuit includes a test mode in which the number of times the specific command can be executed is not limited.

Embodiments of the invention also relate to a handheld device including an integrated circuit according to one of the above embodiments.

Embodiments of the invention also relate to a method for carrying out a cryptographic session in an integrated circuit including a cryptographic algorithm, a countermeasure configured to protect the cryptographic algorithm against side-channel attacks, and a mask generator configured to provide the countermeasure with mask values. The method includes receiving a specific command requiring the disclosure of mask values used by the countermeasure to protect the cryptographic algorithm during the cryptographic session, and in response to said specific command, sending the mask values.

According to one embodiment, the method includes storing in a secure memory, during the cryptographic session, random or pseudo-random mask values used by the countermeasure to protect the cryptographic algorithm, and in response to the specific command, reading the mask values in the secure memory.

According to one embodiment, the method includes, during the cryptographic session, generating mask values from a deterministic sequence number, and in response to the specific command, regenerating the mask values via the deterministic sequence number.

According to one embodiment, the method includes steps of counting the number of times the specific command was executed, and not executing the command if it has been executed N times.

According to one embodiment, the method includes performing a security step if the specific command is received after having been executed N times.

According to one embodiment, the method includes permanently locking the integrated circuit if the specific command is received after having been executed N times.

According to one embodiment, the method includes determining the number N of times the specific command can be executed in order that N is lower than the estimated number of times that would be necessary for an attacker knowing the mask values to successfully carry out a side-channel attack of the cryptographic algorithm.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a conventional integrated circuit implementing a cryptographic algorithm;

FIG. 2 shows an integrated circuit implementing a first type of cryptographic algorithm in accordance with an embodiment of the invention;

FIGS. 3A, 3B are flowcharts describing embodiments of the first type of cryptographic algorithm;

FIG. 4 shows an integrated circuit implementing a second type of cryptographic algorithm in accordance with an embodiment of the invention;

FIGS. 5A, 5B are flowcharts describing embodiments of the second type of cryptographic algorithm;

FIG. 6 is a flowchart describing a variant of the first and second types of cryptographic algorithms; and

FIG. 7 shows a handheld device including an integrated circuit according to embodiments of the invention.

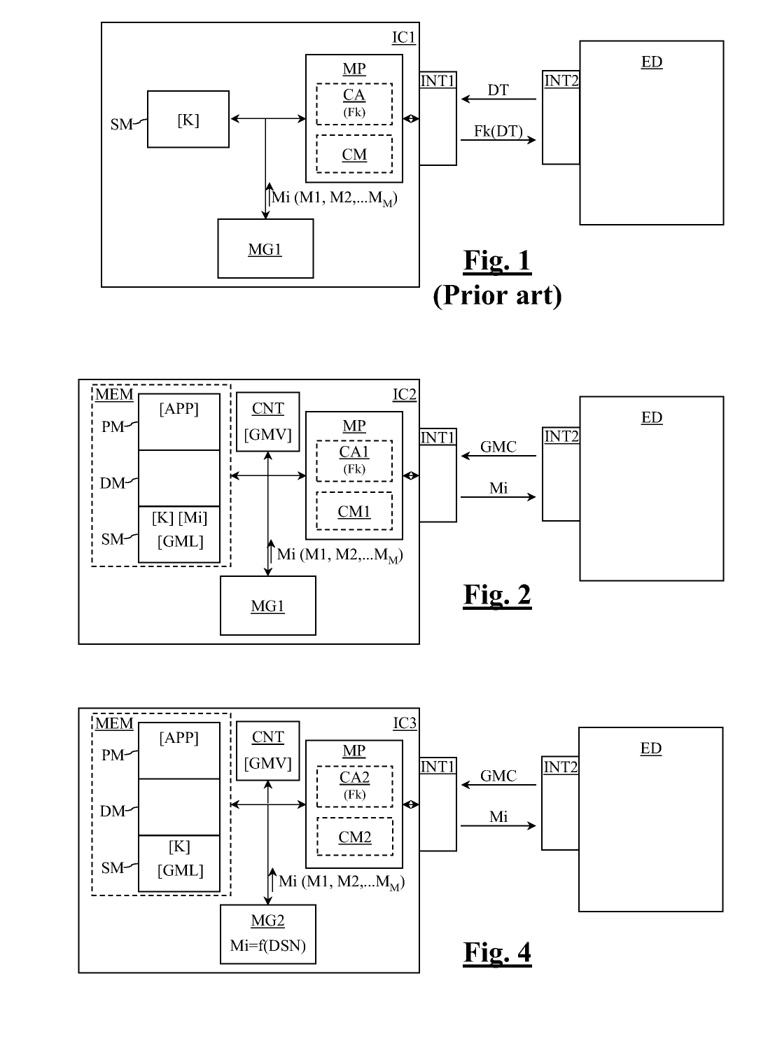

### DETAILED DESCRIPTION OF THE INVENTION

An integrated circuit IC2 implementing a first type of cryptographic algorithm in accordance with an embodiment of the invention is shown in FIG. 2. The integrated circuit IC2 includes a microprocessor or microcontroller MP, a memory area MEM, a cryptographic algorithm CA1, a countermeasure CM1, and a mask generator MG1 including a random or pseudo-random number generator. The integrated circuit IC2 also has a communication interface circuit INT1 to exchange data with an external device ED such as a chip card reader, which also includes a communication interface circuit INT2. The communication interface circuits INT1, INT2 may include contacts, such as ISO 7816 contacts, or a contactless interface circuitry such as a Near Field Communication (NFC) interface circuit, complying, for example, with one of standards ISO 14443 and ISO 15693.

The memory MEM includes a secure memory SM that contains at least one secret key K for the cryptographic algorithm CA1 and may also include other data to be secured, for example a Personal Identification Number (PIN) code. The memory may also include a program memory area PM and a data memory area DM. The program memory may contain application program(s) APP and the data memory DM may contain application data. The cryptographic algorithm CA1 performs a cryptographic function FK using the secret key K to transform initial data DT into encrypted data FK(DT). The cryptographic algorithm CA1 may be of any known suitable type such as Data Encryption Standard (DES), Advanced Encryption Standard (AES), hash functions and RSA, among others. Depending upon the type of cryptographic algorithm performed, the key K can be, for example, public or private.

The cryptographic algorithm CA1 as well as the countermeasure CM1 can be hardware, software or both. In particular, the cryptographic algorithm CA1 may be implemented as a program stored in the program memory PM and executed by the microprocessor, or may be a cryptographic coprocessor linked to the microprocessor through data and address buses and receiving from the microprocessor data and instructions to encrypt the data. The countermeasure CM1 may be particular countermeasure steps embedded within the cryptographic software and executed by the microprocessor, or executed by the cryptographic coprocessor. According to the embodiment chosen for implementing cryptographic algorithm CA1 and the countermeasure CM1, the mask generator MG1 may be controlled either by the microprocessor or by the cryptographic coprocessor.

During the execution of one session of the cryptographic algorithm CA1, corresponding to the transformation of input data DT into encrypted data FK(DT), the mask generator MG1 generates one or more random or pseudo-random numbers that are used as countermeasure mask values Mi (M1, M2, . . . MM) by the countermeasure CM1. In the following, it will be assumed that a cryptographic session carried out by the cryptographic algorithm CA1 and countermeasure CM1 involves M mask values Mi with M≧1. As indicated above, such mask values are used by the countermeasure CM1 to “obscure” the operation of the cryptographic algorithm CA1, so that it is leak-resistant and can resist side-channel attacks.

According to embodiments of the invention, the microprocessor is configured to execute a GetMask command that is received from the outside through the communication interface circuit INT1.

Such a GetMask command can be received after a cryptographic session has been performed or before it is performed.

The microprocessor processes the command and sends the requested mask value Mi through the communication interface under certain conditions that will be detailed below.

If the GetMask command is received before the cryptographic session is performed the microprocessor preferably waits until the session is completed before processing the command but in certain conditions may also execute the command before the cryptographic session is performed if all the mask values involved in the protection of the cryptographic session have already been generated. In some embodiments, it may be provided that the GetMask command is ignored if it is received before the cryptographic session is performed, while it is being performed, or too long after it was performed.

According to an aspect of this embodiment of the cryptographic algorithm CA1, the mask values Mi involved in the cryptographic session are stored in the secure memory SM during the cryptographic session, so as to allow the GetMask command to be processed.

Such a command may be sent by anyone using the external device ED, such as an administrator, a developer, or a technician, so as to perform test and/or debug operations on the cryptographic algorithm CA1. It may also be sent by a fraudster wanting to get the mask values in order to carry out side-channel attacks.

To ensure security against fraudsters, the microprocessor also includes a counter CNT, which is configured to store a first parameter designated “GetMaskValue” or “GMV”, and is used to count the number of times the GetMask command has been executed by the integrated circuit IC2. Counter CNT may be a hardware secure counter linked to the microprocessor, as shown in FIG. 2, or a digital counter located in the secure memory SM, managed by the microprocessor or the cryptographic algorithm CA1.

A second parameter designated “GetMaskLimit” or “GML” is also provided, to define the maximum number of times the GetMask command can be executed by the integrated circuit IC2. This parameter is, for example stored, in a protected register or, as shown in FIG. 2, in the secure memory SM. It may be loaded in the register or the secure memory at the same time the secret key K is stored in the secure memory, for example during the conventional personalization process of secure integrated circuits for chip cards.

The predetermined limit GML is preferably set at a value lower than the estimated number of times that would be necessary for an attacker knowing the mask values to successfully carry out a side-channel attack of the cryptographic algorithm CA1.

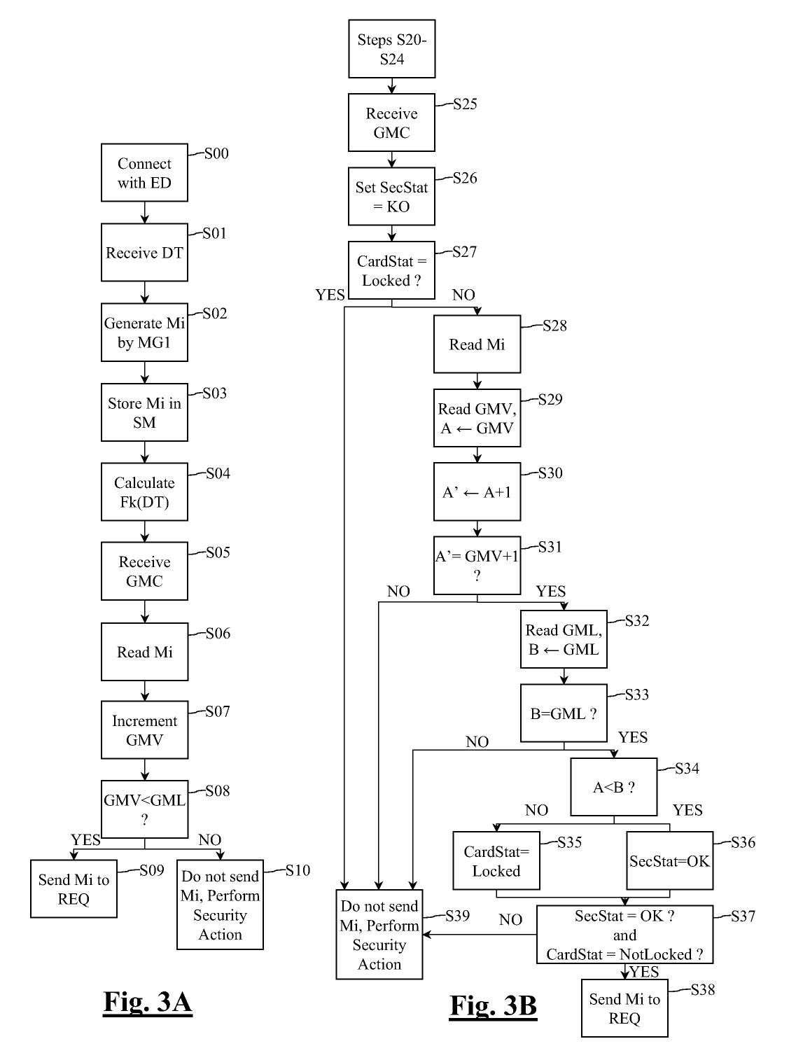

Parameters GMV and GML are used by the microprocessor to determine whether a GetMask command can be executed or not as it will better understood in light of example embodiments of the cryptographic algorithm CA1 shown in FIGS. 3A and 3B.

FIG. 3A is a flowchart showing the main steps of an embodiment of the cryptographic algorithm CAL1. The cryptographic algorithm CA1 includes the following steps S00 to S10:

Step S00: the microprocessor connects with the external device ED and performs conventional operations, like exchanging data and receiving commands, such as an authentication command requiring data to be encrypted and sent to the external device;

Step S01: the microprocessor MP receives data DT to be encrypted through the communication interface circuit INT1, and starts a cryptographic session during which data DT will be processed so as to produce encrypted data FK(DT);

Step S02: the mask generator MG1 generates mask values Mi (M1, M2, . . . MM) from random or pseudo-random numbers (as indicated above, only one mask value Mi may be generated according to the type of cryptographic function implemented by the cryptographic algorithm CA1 and of the type of countermeasure implemented by the countermeasure CM1);

Step S03: mask values Mi are stored in the secure memory SM by the microprocessor or the cryptographic algorithm;

Step S04: a cryptographic session is performed, encrypted data FK(DT) are calculated by the cryptographic algorithm CA1 using the key K stored in the secure memory, and the countermeasure CM1 uses mask values Mi during the cryptographic session to protect the cryptographic algorithm against side-channel attacks;

Step S05: the GetMask command is received by the microprocessor (as indicated above, the GetMask command may also be received before the cryptographic session is performed);

Step S06: the microprocessor reads the mask value Mi in the secure memory SM;

Step S07: the counter CNT is incremented to obtain an incremented GetMaskValue (GMV);

Step S08: the microprocessor performs a comparison between GetMaskValue and GetMaskLimit, to verify that GMV is less than GML, then goes to step S09 if GMV is less than GML or to step S10 if GMV is greater than or equal to GML;

Step S09: the microprocessor sends mask values Mi to the external device, then waits for further instructions or processes further data;

Step S10: the microprocessor does not send mask values Mi to the external device. In addition, the microprocessor may perform a security action.

The security action that may be performed by the integrated circuit is, for example, to permanently or temporarily lock the integrated circuit, to destroy the secret key K in the secure memory, or the like. If the integrated circuit is permanently locked, it can no longer be used or at least can no longer be used to perform a cryptographic algorithm. If the locking is temporary, then the integrated circuit can be reset, such as after a certain amount of time, or through the use of an unlocking code.

FIG. 3B is a flowchart showing the main steps of another embodiment of the cryptographic algorithm CA1. This embodiment involves two security parameters CardStat (Card Status) and SecStat (Security Status) that are defined. CardStat may be stored in the secure memory SM for the entire life of the card, while SecStat may be temporarily stored as local variable in each transaction in the secure memory or another section of the memory MEM, or a register, a latch, or the like. SecStat can be set to two different values, “OK” or “KO”. CardStat can be set to two different values, Locked or NotLocked. The cryptographic algorithm CA1 includes the following steps S20 to S39:

Steps S20 to S24 are identical to steps S00 to S04 previously described and will not be described again;

Step S25: the GetMask command is received by the integrated circuit (as indicated above, the GetMask command may also be received before the cryptographic session is performed);

Step S26: SecStat is set to KO;

Step S27: the microprocessor verifies whether the CardStat is set to Locked: if the CardStat is set to Locked, then the microprocessor goes to step S39, otherwise it goes to step S28;

Step S28: the microprocessor reads the mask value Mi in the secure memory SM;

Step S29: the microprocessor reads GMV in the counter and memorizes it as variable A;

Step S30: the value of A is increased to obtain an incremented variable A′, for example A is incremented by 1;

Step S31: the microprocessor compares variable A′ to a value of GMV incremented by the same value that variable A was increased by, here GMV is incremented by 1: if variable A′ and the incremented value of GMV are not equal, then the microprocessor goes to step S39, otherwise the microprocessor goes to step S32;

Step S32: the microprocessor reads GML in the secure memory and memorizes it as variable B;

Step S33: variable B and GML are compared: if variable B and GML are not equal, then the microprocessor goes to step S39, otherwise the microprocessor goes to step S34;

Step S34: a comparison is performed between variable A and variable B to determine if A is less than B. If variable A is greater than or equal to variable B, then the microprocessor goes to step S35, otherwise the microprocessor goes to step S36;

Step S35: CardStat is set to Locked;

Step S36: SecStat is set to OK;

Step S37: after steps S35 or S36, the microprocessor determines whether CardStat is set to NotLocked and whether SecStat is set to OK: if both conditions are met, the microprocessor goes to step S38, otherwise the microprocessor goes to step S39;

Step S38: the mask values Mi are sent to the external device;

Step S39: the microprocessor does not send the mask values Mi and performs a security action of the type suggested above.

The next time the process is performed, if the CardStat has been set to Locked, the microprocessor will go from step S27 to step S39, so that it will not send the mask values Mi and will perform a security action.

Such an embodiment is also protected against fault-injection attacks. For example, if a fault injection has occurred at step S29 or S30, this will result in A′ different from GMV+1 at step S31 and cause the microprocessor to go to step S39.

FIG. 4 shows a second embodiment of an integrated circuit IC3, in accordance with the invention. Integrated circuit IC3 includes a cryptographic algorithm CA2, a countermeasure CM2, and a mask generator MG2, as well as secure memory SM, microprocessor MP, counter CNT, and communication interface circuit INT1 previously described. The mask generator MG2 differs from the mask generator MG1 of integrated circuit IC2 in that it uses a deterministic sequence number or “DSN” for generating the mask values Mi(M1, M2, . . . MM). The use of DSN to supply mask values for countermeasures in cryptographic algorithms is disclosed in the international patent application PCT/FR2008/001544 which is hereby incorporated by reference. International Patent Applications PCT/FR2009/000071 and PCT/FR2009/000072, which are also hereby incorporated by reference, disclose examples of cryptographic algorithms including a countermeasure using DSN.

During a cryptographic session, a sequence of mask values Mi (M1, M2, . . . MM) is generated from a deterministic function by the mask generator MG2 and from at least one secret parameter stored in the secure memory, called the “seed”. The mask values Mi are therefore generated in a reproducible manner. Consequently, to execute the GetMask command, it is no longer necessary that the mask values Mi be stored in the secure memory during the cryptographic session, since they can be regenerated by the mask generator MG2.

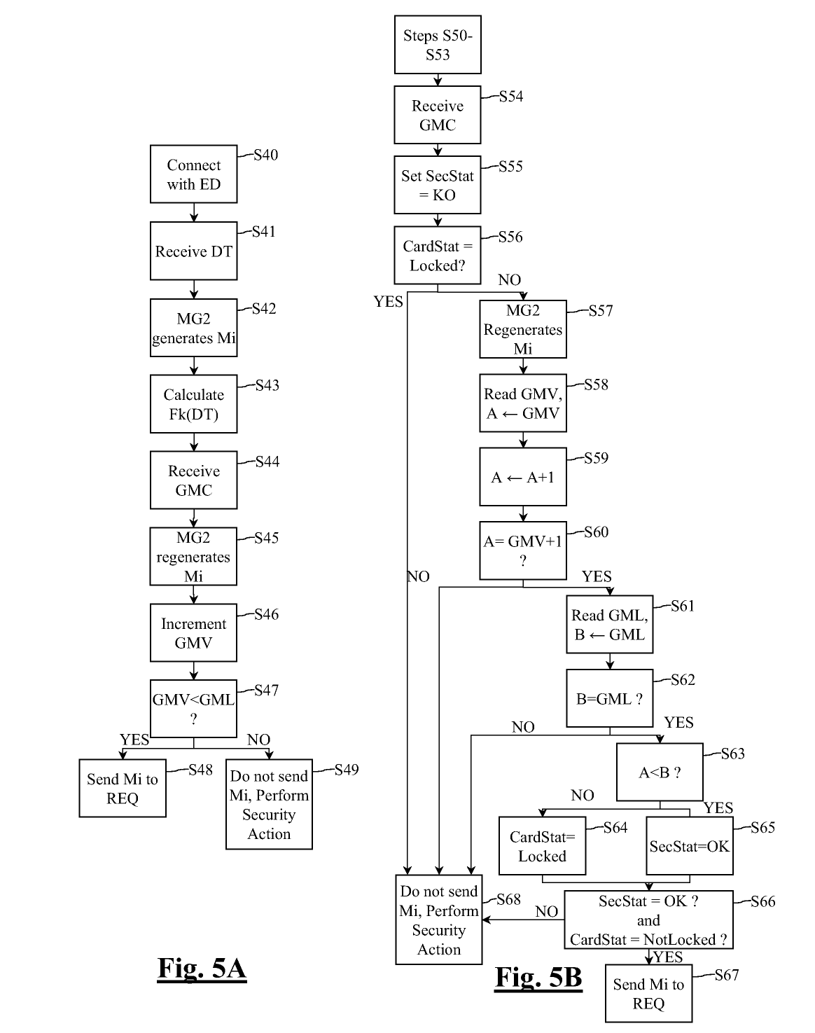

FIG. 5A is a flowchart showing the main steps of an embodiment of the cryptographic algorithm CA2. The cryptographic algorithm CA2 includes the following steps S40 to S49:

Step S40: the microprocessor connects with the external device ED and performs conventional operations, like exchanging data and receiving commands, such as an authentication command requiring data to be encrypted then sent to the external device;

Step S41: the microprocessor MP receives data DT to be encrypted through the communication interface circuit INT1, and starts a cryptographic session during which data DT will be processed so as to produce encrypted data FK(DT);

Step S42: the mask generator MG2 generates mask values Mi (M1, M2, . . . MM) from a DSN. As indicated above, only one mask value Mi may be generated according to the type of cryptographic function implemented by the cryptographic algorithm CA2 and the type of countermeasures implemented by the countermeasure CM2;

Step S43: a cryptographic session is performed, encrypted data FK(DT) are calculated by the cryptographic algorithm CA2 using the key K stored in the secure memory, and the countermeasure CM2 uses mask values Mi during the cryptographic session to protect the cryptographic algorithm against side-channel attacks;

Step S44: the GetMask command is received by the microprocessor (as indicated above, the GetMask command may also be received before the cryptographic session is performed);

Step S45: the mask generator MG2 regenerates the mask values Mi from the DSN, and supplies them to the microprocessor;

Step S46: the counter CNT is incremented to obtain an incremented GetMaskValue (GMV);

Step S47: the microprocessor performs a comparison between GetMaskValue and GetMaskLimit, to verify that GMV is less than GML, then goes to step S48 if GMV is less than GML or to step S49 if GMV is greater than or equal to GML;

Step S48: the microprocessor sends mask values Mi to the external device, then waits for further instructions or processes another data;

Step S49: the microprocessor does not send mask values Mi to the external device. In addition, the microprocessor may perform a security action of the type described above.

FIG. 5B is a flowchart showing the main steps of another embodiment of the cryptographic algorithm CA2. This embodiment involves the previously described security parameters CardStat (Card Status) and SecStat (security status) and includes the following steps S50 to S68:

Steps S50 to S53 are identical to steps S40 to S43 previously described and will not be described again;

Step S54: the GetMask command is received by the integrated circuit (as indicated above, the GetMask command may also be received before the cryptographic session is performed);

Step S55: SecStat is set to KO;

Step S56: the microprocessor verifies whether the CardStat is set to Locked: if the CardStat is set to Locked, then the microprocessor goes to step S68, otherwise it goes to step S57;

Step S57: the mask generator MG2 regenerates the mask values Mi from the DSN, and supplies them to the microprocessor;

Step S58: the microprocessor reads GMV in the counter and memorizes it as variable A;

Step S59: the value of A is increased to obtain an incremented variable A′, for example A is incremented by 1;

Step S60: the microprocessor compares variable A′ to a value of GMV incremented by the same value that variable A was increased by, here GMV is incremented by 1: if variable A′ and the incremented value of GMV are not equal, then the microprocessor goes to step S39, otherwise the microprocessor goes to step S32;

Step S61: the microprocessor reads GML in the secure memory and memorizes it as variable B;

Step S62: variable B and GML are compared: if variable B and GML are not equal, then the microprocessor goes to step S68, otherwise the microprocessor goes to step S63;

Step S63: a comparison is performed between variable A and variable B to determine if A is less than B. If variable A is greater than or equal to variable B, then the microprocessor goes to step S64; otherwise the microprocessor goes to step S65;

Step S64: CardStat is set to “Locked”;

Step S65: SecStat is set to OK;

Step S66: after step S64 or S65, the microprocessor determines whether CardStat is set to NotLocked and whether SecStat is set to OK: if both conditions are met, the microprocessor goes to step S67, otherwise the microprocessor goes to step S68;

Step S67: the mask values Mi are sent to the external device;

Step S68: the microprocessor does not send the mask values Mi and performs a security action of the type described above.

In a further embodiment of the invention, the integrated circuit includes a Test Mode into which it can be switched during testing, debugging, and personalization of the integrated circuit. The test mode is thereafter preferably rendered inaccessible when the integrated circuit is to be commercialized, for example by blowing fuses inside the integrated circuit. It may be provided that the integrated circuit in Test Mode is configured to send the mask values Mi every time it is requested. In this manner, the developers and manufacturers can test and debug the cryptographic circuit as needed.

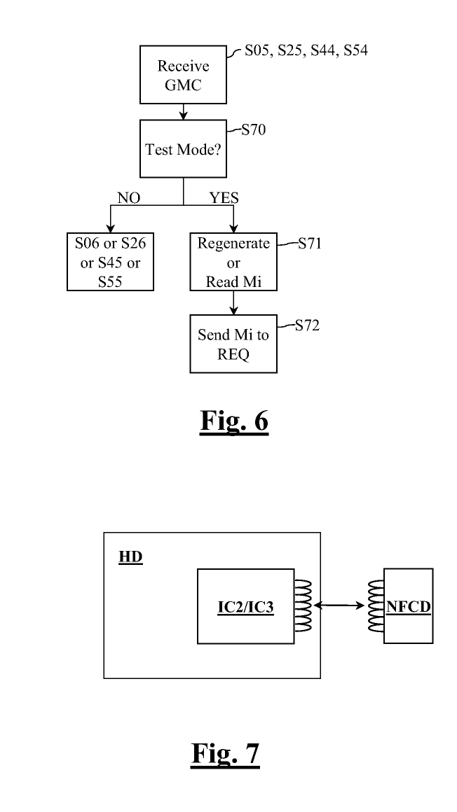

FIG. 6 is flowchart of the cryptographic algorithm according to this embodiment of the invention. The cryptographic algorithm may be derived from any of the embodiments of the cryptographic algorithms CA1, CA2 previously described. It includes a test step S70 that can be performed after one of steps 505, S25, S44, and S54 previously described. Step S70 includes determining whether the microprocessor is in test mode or not. If it is not in test mode, the microprocessor goes to one of steps S06, S26, S45 or S55 previously described. If the microprocessor is in test mode, it executes steps S71 and S72. In step S71, the microprocessor reads the mask values Mi in the memory (if generated by MG1) or has them regenerated by the mask generator MG2. In step S72, the mask values Mi are sent to the external device.

It will appear to the skilled person that the present invention is susceptible of various other embodiments. In particular, the steps that have been described can be implemented in various other manners, such as steps of incrementing the counter, steps of comparing GMV and GML, and the like. For example, counter CNT can be decremented each time a GetMask command is received, and the security action performed when the counter reaches zero or a predetermined low value. Equally, though it has been indicated above that some steps of the cryptographic algorithms according to the invention are performed, controlled or triggered by a microprocessor, in particular steps S06 to S08, S26 to S37, S45 to S47, S55 to S66, such steps may also be performed, controlled or triggered by a dedicated hard-wired state machine embedded in the microprocessor or embedded in the cryptographic algorithm CA1, CA2 if it is implemented as a coprocessor. Likewise, step S03 of storing the mask values Mi during a cryptographic session may be performed by the microprocessor or by the cryptographic algorithm CA1, CA2 if it is implemented as a coprocessor, or by a dedicated hard-wired state machine embedded in the microprocessor or embedded in the cryptographic algorithm CA1, CA2. Also, though the mask generator MG1, MG2 has been represented in the drawings as a separate component with respects to the microprocessor or the cryptographic algorithm CA1, CA2, the mask generator MG1, MG2 may also be implemented in the form of a program executed by the microprocessor, or in the form of a dedicated hardwired circuit embedded in the microprocessor or in the cryptographic algorithm CA1, CA2 if it is implemented as a coprocessor, or embedded in a dedicated hard-wired state machine embedded in the microprocessor or embedded in the cryptographic algorithm CA1, CA2. Finally, embodiments of the invention may also be implemented in an integrated circuit without a microprocessor, in which the commands and the different steps described above are executed by a hard-wired state machine.

It will also appear to the skilled person that an integrated circuit including a cryptographic algorithm according to the invention is also susceptible of various applications. As an application example, FIG. 7 schematically shows a handheld device HD in which integrated circuit IC2 or IC3 is embedded. The handheld device HD may be a chip card, a tag, a mobile phone, a Personal Digital Assistant, or the like. Integrated circuit IC2 or IC3 is connected to an antenna coil and is configured to exchange data and perform transaction with an NFC external device NFCD such as a contactless card or tag reader, an NFC Point of Sale, another NFC mobile phone, or the like.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An integrated circuit comprising:
a communication interface circuit;
a cryptographic algorithm;
a countermeasure configured to protect the cryptographic algorithm against side-channel attacks; and
a mask generator configured to provide the countermeasure with mask values,
wherein the integrated circuit is configured to execute a specific command requiring the disclosure of mask values used by the countermeasure to protect the cryptographic algorithm during a cryptographic session, and, in response to the specific command, to send the mask values through the communication interface circuit.

2. The integrated circuit according to claim 1, wherein the mask generator is a random or pseudo-random mask generator configured to:
store in a secure memory, during a cryptographic session, mask values used by the countermeasure to protect the cryptographic algorithm, and
in response to the specific command, read the mask values in the secure memory.

3. The integrated circuit according to claim 1, wherein the mask generator is configured to generate mask values from a deterministic sequence number, and the integrated circuit is configured to, in response to the specific command, regenerate, via the mask generator, mask values used during a cryptographic session.

4. The integrated circuit according to claim 1, configured to count a number of times the specific command was previously executed, and to not execute the specific command if the specific command has been previously executed N times.

5. The integrated circuit according to claim 4, configured to perform a security action if the specific command is received after having been previously executed N times.

6. The integrated circuit according to claim 5, configured to permanently lock if the specific command is received after having been previously executed N times.

7. The integrated circuit according to claim 4, wherein the number N of times the specific command is permitted to be executed is defined by a parameter securely stored in the integrated circuit.

8. The integrated circuit according to claim 4, configured so that the number N of times the specific command is permitted to be executed is lower than an estimated number of times that would be necessary for an attacker knowing the mask values to successfully carry out a side-channel attack of the cryptographic algorithm.

9. The integrated circuit according to claim 4, further comprising a test mode in which the number of times the specific command is permitted to be executed is not limited.

10. A handheld device comprising an integrated circuit according to claim 1.

11. A method for carrying out a cryptographic session in an integrated circuit including a cryptographic algorithm, a countermeasure configured to protect the cryptographic algorithm against side-channel attacks, and a mask generator configured to provide the countermeasure with mask values, the method comprising:
receiving a specific command requiring the disclosure of mask values used by the countermeasures to protect the cryptographic algorithm during the cryptographic session, and
in response to the specific command, sending the mask values.

12. The method according to claim 11, further comprising:
storing in a secure memory, during the cryptographic session, random or pseudo-random mask values used by the countermeasures to protect the cryptographic algorithm, and
in response to the specific command, reading the mask values in the secure memory.

13. The method according to claim 11, further comprising:
during the cryptographic session, generating mask values from a deterministic sequence number, and
in response to the specific command, regenerating the mask values via the deterministic sequence number.

14. The method according to claim 11, further comprising counting a number of times the specific command was previously executed, and not executing the specific command if the specific command has been previously executed N times.

15. The method according to claim 14, further comprising performing a security step if the specific command is received after having been previously executed N times.

16. The method according to claim 15, further comprising permanently locking the integrated circuit if the specific command is received after having been previously executed N times.

17. The method according to claim 14, further comprising determining the number N of times the specific command is permitted to be executed such that N is lower than an estimated number of times that would be necessary for an attacker knowing the mask values to successfully carry out a side-channel attack of the cryptographic algorithm.
